(19) United States
(12) Patent Application Publication
(10) Pub. No.: US 2016/0046226 A1
(43) Pub. Date: Feb. 18, 2016

(54) UNLOADING DEVICE FOR USE WITH A PICK-UP TRUCK

(71) Applicant: Unload It LLC, Canal Fulton, OH (US)

(72) Inventors: James N. Caplea, II, Canal Fulton, OH (US); David Slicker, Massillon, OH (US)

(73) Assignee: Unload It LLC

(21) Appl. No.: 14/821,217

(22) Filed: Aug. 7, 2015

Related U.S. Application Data
(60) Provisional application No. 62/036,252, filed on Aug. 12, 2014.

(51) Int. Cl. B60P 1/64

(52) U.S. Cl. CPC B60P 1/64

(57) ABSTRACT

An unloading device or an unloader for a personal pick-up truck includes a support arm received by the truck hitch with a cross support bar positioned rearwardly therefrom. The cross support bar does not contact the tailgate. The cross support arm includes a pair of bearings housed within respective collars receiving a rod therethrough. A fabric web is attached to the rod and configured to move between a rolled and unrolled position. When in the unrolled position, the fabric web rests atop a surface on the truck bed and it configured to receive bulk material thereon. The rod may be rotated to wind the fabric web onto the rod to unload the bulk material stored in the truck bed.

### CROSS REFERENCE TO RELATED APPLICATION

This disclosure claims priority to and the benefit of U.S. Provisional Application Ser. No. 62/036,252 filed on Aug. 12, 2014, the entirety of which is incorporated herein by reference as if fully rewritten.

### BACKGROUND

1. Technical Field

The present disclosure relates generally to a pick-up truck accessory. More particularly, the present disclosure relates to a pick-up truck accessory including a fabric web of material configured to unload bulk material from a pick-up truck bed. Specifically, the present disclosure includes an unloading device for use with a pick-up truck purposefully separated from the tailgate of the pick-up truck in order to reduce damage to the tailgate while bulk materials are unloaded from the pick-up truck bed to a desired location.

2. Background Information

Commercial landscapers and weekend warriors alike, use pick-up trucks to haul bulk materials, such as mulch, gravel, top soil, river rocks, or bricks, in their pick-up truck beds. The truck beds are often capable of carrying large quantities of bulk material that one would not be able to haul in an ordinary vehicle, such as a sedan. When transporting bulk material in a truck bed, one problem that sometimes arises is how to get the bulk material out of the pick-up truck bed. Sometimes an operator will use a shovel and wheel barrow method or an operator will employ some other unique solution.

One previous attempt of solving the solution of unloading bulk materials from a pick-up truck bed is identified in U.S. Pat. No. 5,340,266, issued on Aug. 23, 1994, in the name of Hodgetts (the '266 patent). A second solution is identified in U.S. Pat. No. 5,915,911, issued on Jun. 29, 1999, in the name of Hodgetts (the '911 patent) which was a Continuation-In-Part application from the '266 patent.

The '266 patent and the '911 patent each disclose an unloading device configured for a pick-up truck. Each requires the limitation of the unloading device be attached to the tailgate of the pick-up truck by some sort of strapping material contacting the surface of the pick-up truck tailgate.

### SUMMARY

Issues continue to exist from unloading devices similar to those disclosed in the '266 patent and the '911 patent. The manner in which these devices attach to the tailgate causes stress to (and on) the tailgate which can lead to damage of the tailgate. In operation, the devices in the '266 patent and the '911 patent require the tailgate attach to an unloading device. Then, when in use, the tailgate will raise up when the operator cranks the unloading device in an attempt to move a heavy load from the truck bed. Further, these two devices (aka unloaders) may cause some straps to bang or scratch against the paint causing significant damage to the tailgate. Thus, issues continue to exist with unloading devices for pick-up trucks as currently understood in the prior art. The present disclosure addresses these and other issues.

In accordance with one aspect, an embodiment of the present disclosure may provide an unloading device comprising: a rod for winding a fabric web thereabout, the web configured to unload bulk material from a truck bed when moving from an unwound to a wound position, the web passing over a gap between the rod and a truck tailgate; and a support arm adapted to support the rod at one end and insert into a truck hitch receiver at a second end.

In accordance with one aspect, an embodiment of the present disclosure may provide a pick-up truck unloading device configured to attach to a hitch on a truck, such that the unloading device is separated from the tailgate defining a gap between the unloading device and the top of the tailgate when the tailgate is in a lowered position. The separation of the unloading device from the tailgate protects the tailgate from both physical damage relating to contact of the paint surface as well as damages that may result from stresses imparted to the tailgate during the unloading of bulk materials from the pick-up truck bed.

In accordance with another aspect, an embodiment of the present disclosure may provide an unloading device for unloading bulk material from a pickup truck bed, the unloading device comprising: a rod having a longitudinal axis extending transversely from a left side to a right side relative to a pickup truck bed, the rod rotatable about the longitudinal axis; wherein the rod is positioned rearwardly from the pickup truck bed and the positioning of the rod is independent from movement of a tailgate; and a web of material including one end of the web attached to the rod and the web spoolable on the rod between an unrolled position and a rolled position; wherein the web unloads bulk material carried thereby as the web is spooled from the unrolled position to the rolled position.

In accordance with another aspect, an embodiment of the present disclosure may provide a method of unloading bulk material from a truck bed comprising the steps of: rotating a rod about a longitudinal axis, wherein the rod is supported by a support arm coupled to a hitch receiver underneath the truck bed; spooling a web of material onto the rod from an unrolled position to a rolled position, wherein when the web is in the unrolled position, bulk material is disposed on the web; passing bulk material over a gap defined between the rod and a top surface on a tailgate in a lowered position; and passing bulk material over a top of the web causing the bulk material to fall to the ground.

In accordance with yet another aspect, an embodiment of the present disclosure may provide an unloading device or an unloader for a personal pick-up truck that includes a support arm received by the truck hitch with a cross support bar positioned rearwardly therefrom. The cross support bar does not contact the tailgate. The cross support arm includes a pair of bearings housed within respective collars receiving a rod therethrough. A fabric web is attached to the rod and configured to move between a rolled and an unrolled position. When in the unrolled position, the fabric web rests atop a surface on the truck bed and it configured to receive bulk material thereon. The rod may be rotated to wind the fabric web onto the rod to unload the bulk material stored in the truck bed.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are incorporated in and constitute a part of the specification, illustrate various example methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a side elevation view of an unloading device attached to a hitch receiver on a truck;

FIG. 2 is a perspective view of one exemplary embodiment of the unloading device of the present disclosure;

FIG. 3 is a side elevation view of the unloading device of the present disclosure depicting the unwinding of a fabric web into the truck bed while the unloader is distinctly separated and not contacting the truck tailgate;

FIG. 4 is a top view of the fabric web extending to the front of the truck bed;

FIG. 5 is a cross section view of the rod having the web wound there around taken along line 5-5 in FIG. 4;

FIG. 6 is a side elevation view of an operational embodiment of the present disclosure depicting the rotation of the rod to unload bulk materials;

FIG. 7 is a side elevation view of the unloading device of the present disclosure including additional components attached thereto; and

FIG. 8 is a side elevation view of an alternate embodiment of an unloading device of the present invention.

Similar numbers refer to similar parts throughout the drawings.

### DETAILED DESCRIPTION

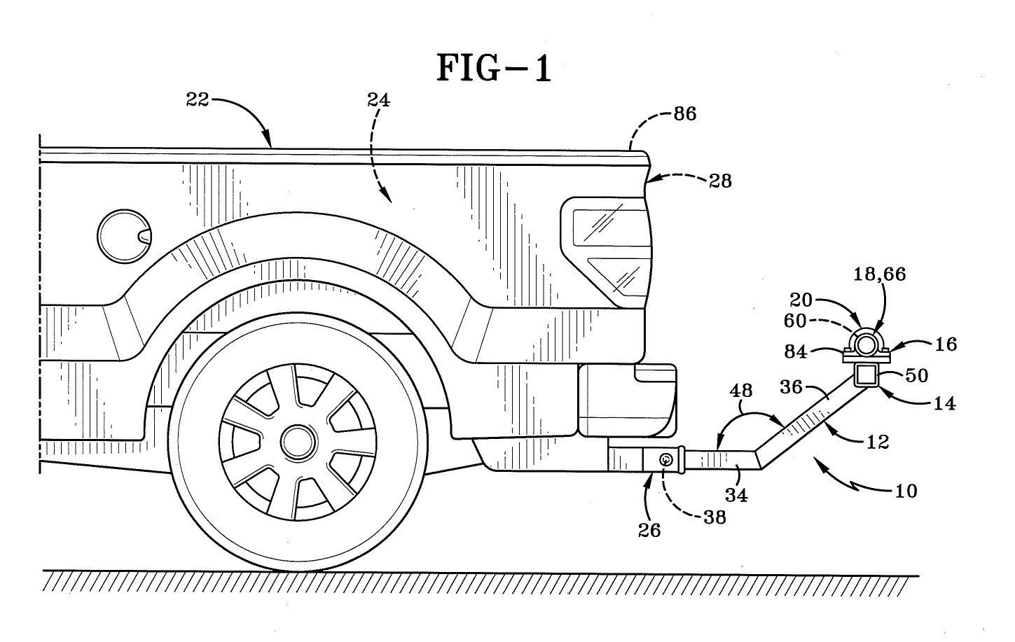

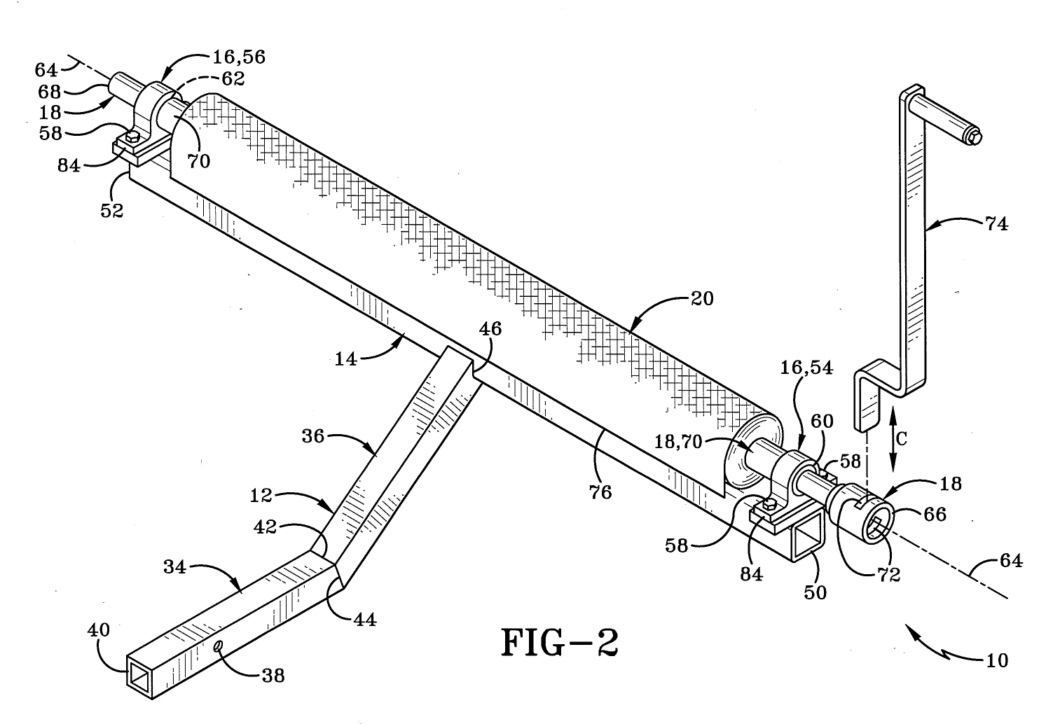

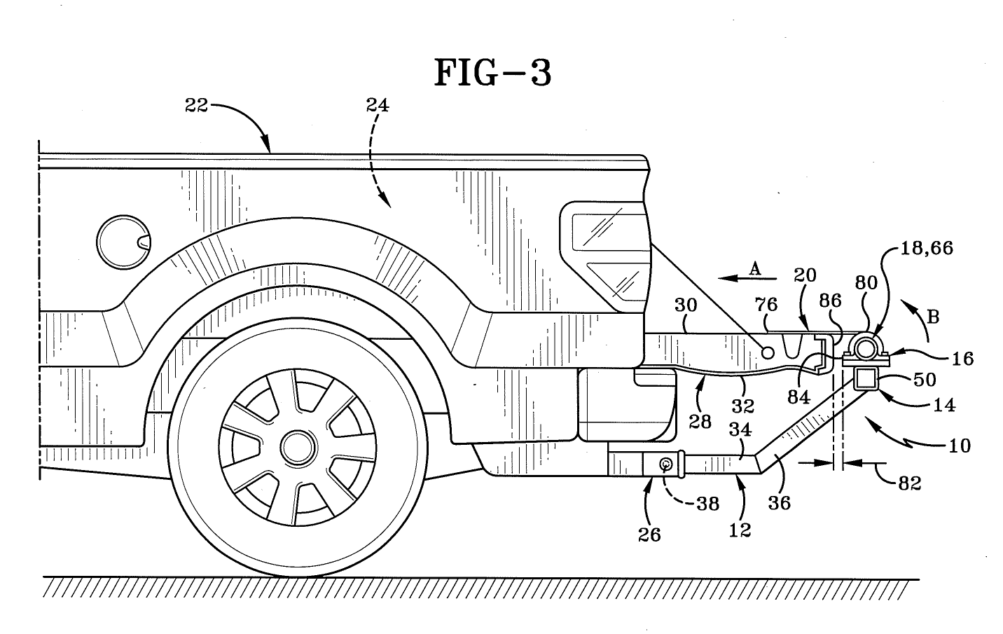

As depicted in FIG. 1, an unloading device 10 may include a support arm 12, a cross support 14, a set of bearing blocks 16, a winding rod 18, and a fabric web 20 (FIG. 2). Unloading device 10 connects to a hitch receiver 26 beneath the truck bed 24 of a pick-up truck 22. Pick-up truck 22 further includes a tailgate 28 defining a rear end of the pick-up truck 22 extending transversely from left side to right side. Tailgate 28 is selectively movable between an open or lowered horizontally extending position and a closed or raised vertical position as one having ordinary skill in the art would understand. When the tailgate 28 is in the closed position, the tailgate 28 is generally vertical to form a semi-enclosed container within truck bed 24 and when tailgate 28 is in the open position truck bed 24 is semi-opened allowing contents stored in the truck bed 24 to exit longitudinally rearward from the pick-up truck 22. Tailgate 28 includes a truck bed facing first surface 30 (FIG. 3) opposite a rearward facing tailgate second surface 32 (FIG. 3).

As depicted in FIG. 2, support arm 12 includes a first leg 34 and a second leg 36. First leg 34 is depicted as having a generally hollow square cross section configured to fit within hitch receiver 26 on pick-up truck 22. Although a conventional hitch receiver 26 has a square receiving configuration, it is clearly to be understood that first leg 34 could have a variety of geometric configurations. First leg 34 defines a bolt receiving aperture 38. Bolt receiving aperture 38 extends transversely through first leg 34 through two sidewalls that define the square cross section of first leg 34. A first end 40 is spaced apart from a second end 42 on first leg 34. In one particular embodiment, the first end 40 is positioned forwardly from the second end 42 (relative to the forward position of the truck).

Second leg 36 is rigidly secured to first leg 34 and defines an angle 48 extending between the respective upwardly facing top surfaces on first leg 34 and second leg 36. Second leg 36 includes a first end 44 spaced apart from a second end 46. Second leg 36 is a tube like configuration that is preferably hollow having a generally square cross section similar to that of first leg 34. However, similar to hollow first leg 34, second leg 36 may have alternate geometric cross section configurations as one having ordinary skill in the art would understand.

In one particular embodiment first leg 34 is generally horizontal relative to the ground. Front end 44 of second leg 36 contacts second end 42 of first leg 34. Second leg 36 extends rearwardly and upwardly from its rigid connection with first leg 34. The upwardly facing top surfaces of first leg 34 and second leg 36 define an obtuse angle 48 therebetween. In the particular shown embodiment, angle 48 is obtuse because first leg 34 is shorter than second leg 36. However, there may be instances in which angle 48 is an acute angle, and in those instances first leg 34 would be longer than second leg 36. In other instances, angle 48 may be a right angle.

Cross support 14 includes a left end 50 spaced apart opposite a right end 52. Cross support 14 is a generally tubular square configuration similar to that of support arm 12 defining a hollow bore therethrough. Cross support 14 extends transversely from left to right relative to pick-up truck 22. Cross support 14 is rigidly connected or coupled to second leg 36 of support arm 12 at the transverse midline of cross support 14.

Cross support 14 is positioned at a vertical height higher than that of first leg 34 when viewed from the side. Additionally, cross support 14 is positioned in a manner that is longitudinally rearward from first leg 34 when viewed from the side. When viewed from above, cross support 14 is generally orthogonal to support arm 12 defining a right angle at the rigid connection of cross support 14 to second end 46 of second leg 36 on support arm 12. Additionally, because of the rigid connection between cross support 14 and support arm 12, the cross support 14 remains at a fixed vertical height and a fixed horizontal or longitudinal position at all times during the operation of unloading device 10. Since cross support 14 is operatively connected to hitch receiver 26, the movement of tailgate 28 between its open and closed positions does not affect any movement or position of winding rod 18 which is carried on cross support 14 and described in greater detail below. Stated otherwise, the movement of components in unloading device 10 is completely independent from the movement of tailgate 28.

The pair of bearing blocks 16 include a left collar 54 that is coupled to the top surface of cross support 14 and adjacent left end 50. Collar 54 may be connected to cross support 14 in any conventional mechanical, chemical, or other attaching manner and as shown in FIG. 2 collar 54 is attached to cross support 14 via bolt 58. A first bearing 60 carried in collar 54 concentrically receives rod 18 therethrough. A right collar 56 connects to cross support 14 adjacent right end 52 via bolt 58. Right collar 56 houses second bearing 62 concentrically therein and receives rod 18 therethrough. First and second bearings 60, 62 rotate about the same transverse axis 64. Additionally, while it is contemplated that first and second bearings 60, 62 are to be free-spinning, it is entirely possible that the rod 18 may be power assisted to help the rolling and unrolling of web 20. This may be accomplished through a mechanical member, such as a spring, or through an electromechanical member such as an engine or motor.

Rod 18 is an elongated cylindrical member extending from a left end 66 to a right end 68 along transverse axis 64 concentric with bearings 60, 62. Rod 18 extends through each of the first and second bearings 60, 62. A larger diameter rigid tubular hub or member 70 may be mounted concentrically about rod 18 and positioned transversely inward from collars 54, 56 respectively between the transverse ends of fabric web 20. In one embodiment, hub 70 acts as a spacer between left and right ends of web 20 and the pair of bearing blocks 16. Hub 70 may be fixed to rod 18 to rotate therewith or may freely spin thereon. Rod 18 may have a crank receiving aperture formed adjacent left end 66 to receive a crank arm 74 therethrough. Crank arm 74 is configured to urge the rotation of rod 18 about transverse axis 64. Again, it is possible for the crank arm 74 to be replaced with a powered drive mechanism such as a spring or a motor.

Rod 18 is operatively carried by cross support 14 and is therefore independent from the opening and closing movement of tailgate 28. As mentioned briefly above, the pair of bearing blocks 16 assist the rigid attachment of rod 18 to cross support 14. Each one of the bearing blocks 16 has a downwardly and ground facing bottom surface. The bottom surface of each one of the pair of bearing blocks 16 contacts the upwardly facing top surface of tubular cross support 14. The downwardly facing bottom surface of each one of the pair of bearing blocks 16 faces downwardly at all times during the operational winding (i.e., rolling) of rolled web 20 about rod 18. Stated otherwise, when the tailgate is in the vertically closed position, the downwardly facing bottom surface of each one of the pair of bearing blocks 16 faces the ground. And, when the tailgate is in the open position, the downwardly facing bottom surface of each one of the bearing blocks 16 still faces downward towards the ground.

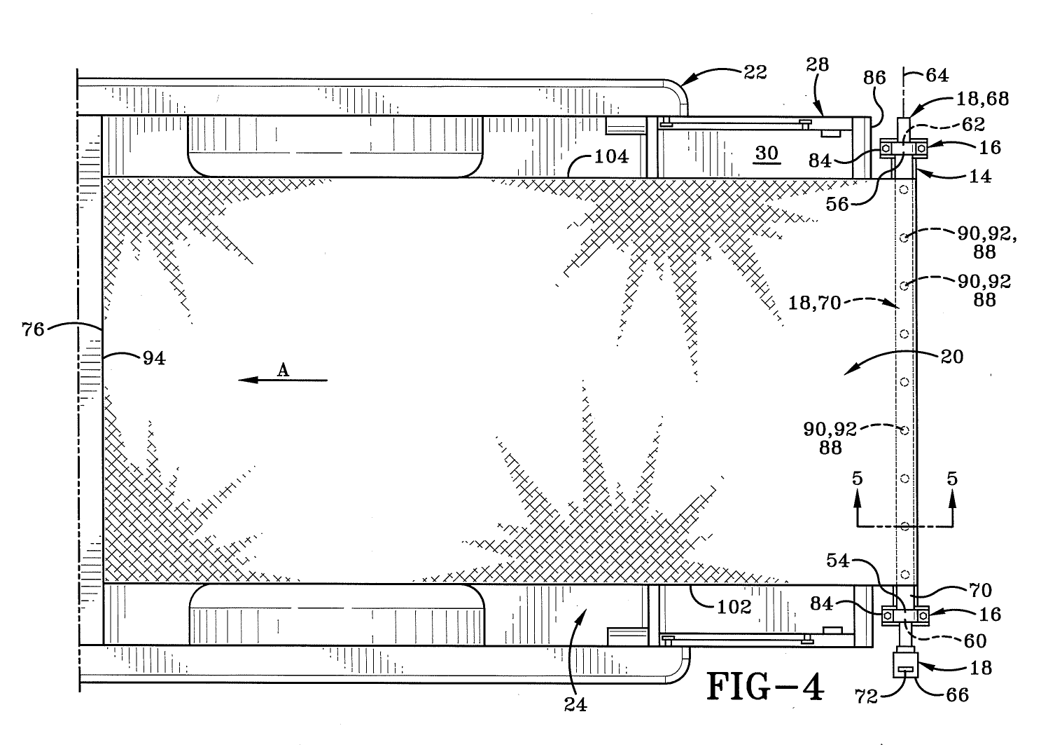

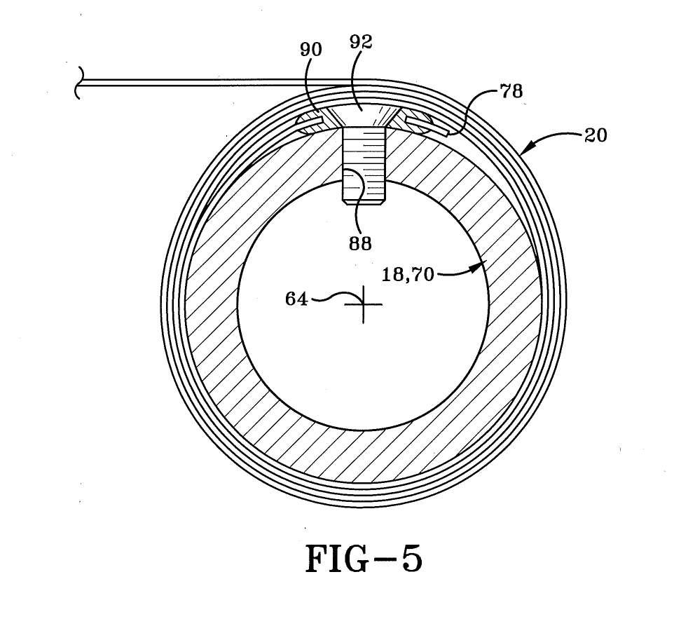

Fabric web 20 includes a first end 76 (FIG. 4). Fabric web 20 is substantially rectangular in shape and is preferably at least equal to the length of the truck bed 24 and more preferably about 25% longer than the truck bed 24. The fabric web 20 width extends from fabric left edge 102 (FIG. 4) to fabric right edge 104 (FIG. 4). The web width is approximately similar to the transverse width of the truck bed 24 floor. First end 76 of web 20 is a free end and a second end 78 (FIG. 5) is fixedly attached to rod 18. Fabric web 20 is preferably made of a high strength plastic material, however, other materials are clearly contemplated. Rolled material/fabric web 20 is convertible between a rolled position (FIG. 2) and an unrolled position (FIG. 4). As will be discussed in greater detail below with respect to the operation of unloading device 10, fabric web 20 may be rotatably moved between the rolled and unrolled position by rotating rod 18 about axis 64 to wind or to spool web 20 there-around.

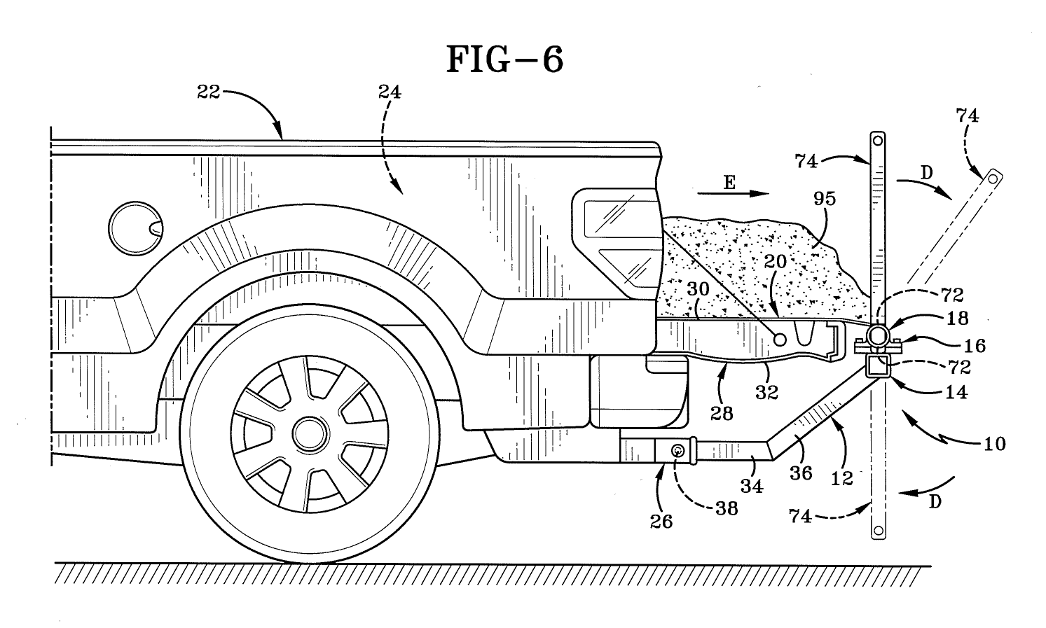

As depicted in FIG. 3 when unloading device 10 is attached to hitch receiver 26, the top 80 of fabric web 20 is at a similar vertical height to that of first surface 30 when tailgate 28 is in the lowered position. Alternatively, the top 80 may be positioned at a similar vertical height to that of the downwardly facing second surface of the tailgate when the tailgate is in a lowered position (See FIG. 6 for this configuration). Further, when the fabric web 20 is in its rolled position (FIG. 2) no part of the unloading device 10 contacts tailgate 28. In its unrolled state, fabric web 20 extends into truck bed 24, fabric web 20 contacts surfaces in truck bed 24, however, no other component of unloading device 10 contacts tailgate 28. A gap 82 is formed between the forward edge 84 on bearing block 16 and the top surface 86 of tailgate 28. The gap 82 is of a sufficient clearance such that when tailgate 28 is opened and closed, it does not contact the components of unloading device 10.

Gap 82 has a longitudinal (which is horizontal when viewed from the side) distance measurement in a range from about 0.25 inches to about six inches. More particularly, gap 82 may be in a range from about 0.5 inches to about three inches. Even further, gap 82 may be in a range of about 0.75 inches to about two inches. Specifically, gap 82 may be one inch.

As depicted in FIG. 4 and FIG. 5, rod 18 defines a plurality of transversely extending aligned apertures 88 therein. Apertures 88 formed through rod 18 are configured to align with a grommet 90 fixedly attached adjacent second end 78 of fabric web 20. Aperture 88 may be threaded to receive screw 92 thus securing second end 78 to rod 18.

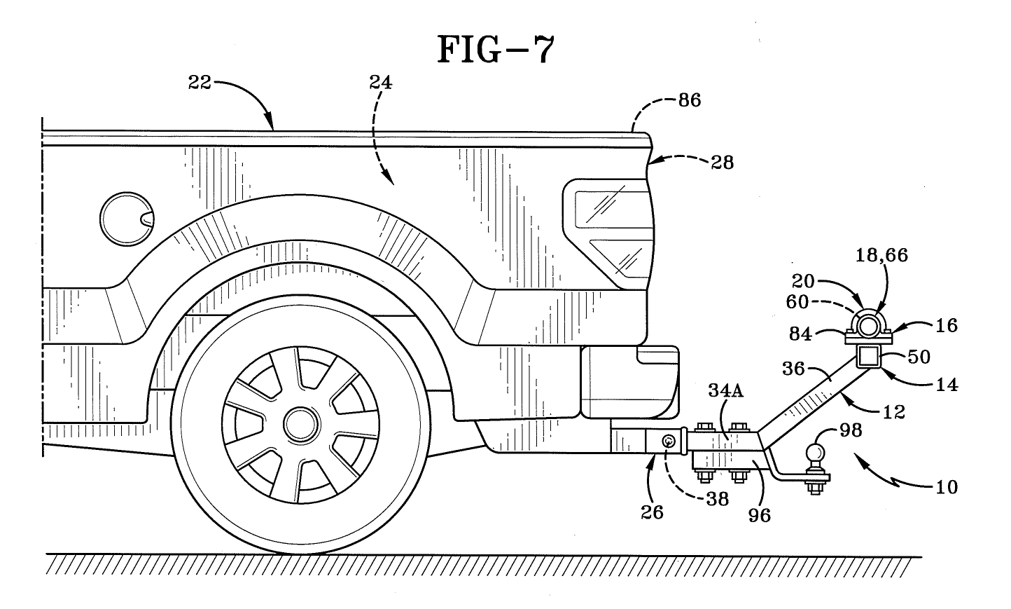

With primary reference to FIG. 7, alternate attachment element 96 may be configured to attach to support arm 12 at leg 34A. Attachment element 96 is shown as having a ball hitch 98. This configuration allows pick-up truck 22 to haul a trailer (not shown) even when unloading device 10 is occupying hitch receiver 26.

Attachment element 96 allows for an implement (not shown) to attach to ball hitch 98. Ball hitch 98 is positioned vertically below second leg 36 and longitudinally rearward from first leg 34a. Ball hitch 98 is positioned longitudinally forward from cross support 14. Attachment element 96 is shown as releasably secured to first leg 34a via a plurality of bolts; however, other means of securing attachment element 96 to support arm 12 is entirely possible. Further it is contemplated that embodiment may be provided where ball hitch may be directly connected to second leg 36 or even an additional hitch receiver supplemental to hitch receiver 26.

In accordance with an aspect of the present invention, unloading device 10 unloads bulk material 95 from a truck bed 24 when the tailgate 28 is in a lowered position. The unloading device 10 allows the tailgate 28 to remain in a lowered position during the unloading process. Stated otherwise, when unloading device 10 is in operation, the tailgate 28 does not lift up or raise due to force exerted thereon, as is common in some prior art unloading devices that are physically connected to a tailgate.

In accordance with another aspect of the present invention, unloading device 10 unloads bulk material 95 from a truck bed 24 and unloading device 10 is purposefully distinct and separated from tailgate 28 on pick-up truck 22. An advantage of purposefully separating unloading device 10 from tailgate 28 is that an operator can reduce the likelihood of damage to the tailgate 28 compared to a conventional unloading device fixedly attached to a top surface of a tailgate.

In accordance with yet another aspect of the invention, unloading device 10 provides a faster way of attaching an unloading device to a truck over some prior art unloading devices that are physically connected to a tailgate. Unloading device 10 is coupled to a support arm 12 that connects to truck via hitch receiver 26 rather than being physically connected to the tailgate, thus an operator can quickly connect or disconnect the device from the truck.

In accordance with another aspect of the present invention, unloading device 10 provides a secure way of connecting second end 78 on fabric web 20 to rod 18. The screw and grommet connection depicted in the present invention permits an operator to forcibly apply more torque through the rotation of crank arm 74 over conventional unloaders which ordinarily attach a second end of the fabric web to the rotational rod via adhesive or tape.

In operation and with respect to FIG. 1, an operator attaches unloading device 10 to hitch receiver 26. The operator aligns first end 40 on leg 34 of support arm 12 with hitch receiver 26 securely mounted on pick-up truck 22. In one particular embodiment, first end 40 is inserted into hitch receiver 26 until aperture 38 is aligned with a bolt receiving aperture formed in hitch receiver 26 and a hitch bolt is extended therethrough to releasably secure support arm 12 to hitch. A set of releasable straps may be removed from fabric web 20 in order to release free end 76 from a stored or rolled position (FIG. 2).

In operation and with reference to FIG. 3 when unloading device 10 is installed or connected to hitch receiver 26, tailgate 28 may be lowered to the open position as shown in FIG. 3. First end 76 of fabric web 20 may be pulled towards the forward end 94 of the truck bed 24 in the direction of arrow A. As the first end 76 of fabric web 20 is pulled in the direction of arrow A, fabric web 20 unwinds from rod 18 about axis 64 in the direction of arrow B.

In operation, with reference to FIG. 4, first end 76 may be pulled all the way to the front 94 of truck bed 24. Alternatively, first end 76 may be pulled past the front end 94 of bed 24 such that the excessively stretched web 20 extends vertically up the sidewall defining front end 94 of bed 24. Bulk material 95 may then be loaded or poured into truck bed 24. Operator will then transport bulk material 95 to a desired site location. During transport, the tailgate may be either raised (closed) or lowered (open) depending on the amount of bulk material 95 that is carried. At a desired site, it is usually preferable for the operator to dump the bulk material 95 in a precise location. One particular non-limiting example may be transporting mulch from a landscape facility to a residential home. When the bulk material 95 is to be unloaded from truck bed 24 the operator will insert an end of crank arm 74 into the receiving aperture 72 in the direction of arrow C (FIG. 2). Operator then cranks crank arm 74 in the rotational direction of arrow D. In the shown embodiment arrow D is rotationally opposite arrow B about transverse axis 64. The rotation of crank arm 74 in the direction of arrow D draws (i.e., winds) fabric web 20 in the direction of arrow E. In the shown embodiment, arrow E is opposite that of arrow A. As crank arm 74 is rotated in the direction of arrow D, bulk material 95 falls to the ground as it passes over the threshold at the top 80 of fabric web 20. Web 20 is then wound (i.e., spooled) onto rod 18.

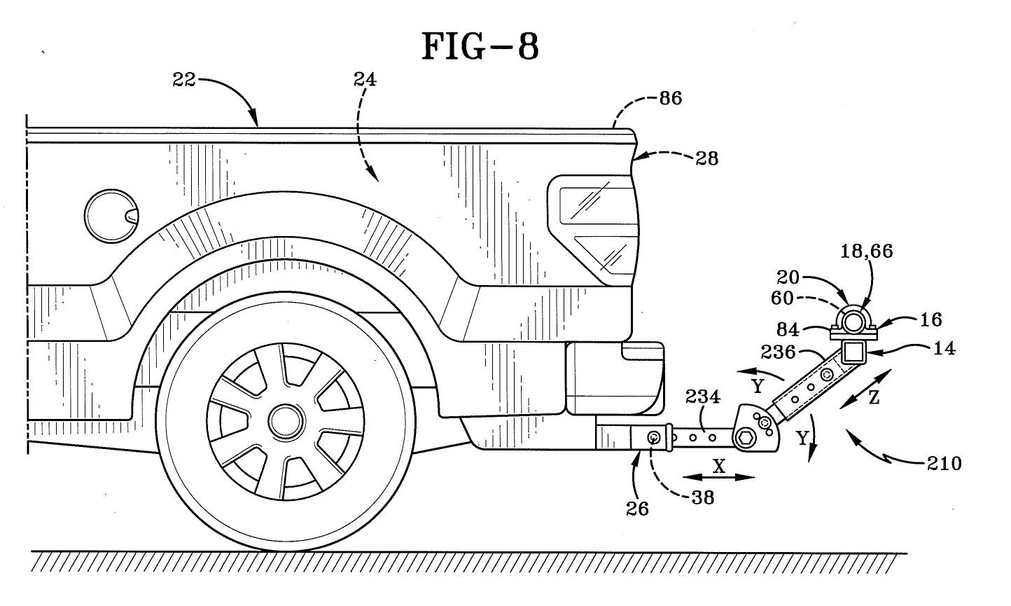

In operation, with respect to FIG. 8, an alternative embodiment of the present invention is depicted as 210. Alternative embodiment 210 is similar to that of unloading device 10 except it may include adjustable elements permitting respective support arms 234, 236 to adjust in the directions along arrows X, Y, and Z respectively. Support arm 234 may longitudinally extend in the direction of arrow X. An angle defined between support arms 234, 236 may vary within the direction of arrow Y. support arms 234, 236 (also referred to as first support leg 234 and second support leg 236) may be pivotably connected to adjust the angle defined between therebetween in the direction of Arrow Y. Support arm 236 may adjust in the direction of arrow Z upwardly and rearwardly as indicated in FIG. 8. The purpose of the adjustability of alternative embodiment 210 is to provide a single unloading device 210 that is configured to fit a wide variety of pick-up truck types. For example, an American, full size truck, such as a Ford F-150 is significantly larger than an American small size truck, such as a Ford Ranger. Unloading device 210 would be convertible and adjustable allowing unloading device 210 to fit on both an American full size pick-up truck and an American small size pick-up truck.

It is desirable that the rigid members, by way of non-limiting example, such as support arm 12, cross support 14, bearing blocks 16, and rod 18, are fabricated from a sufficiently strong material to support the various stresses exerted on unloading device 10 during its operational movement of dumping bulk material. Some exemplary materials that may be used to fabricate the various rigid members of unloading device 10 are metals and other composite materials. A few non-limiting exemplary metals are steel and aluminum and non-limiting exemplary nonmetals may be carbon-fiber or fiberglass, however other rigid materials may be used to fabricate the rigid components of unloading device 10 as one having ordinary fabricating abilities would understand. However, the overall weight of unloading device 10 still must be light enough (i.e., weight less than) to be less than the maximum permitted tongue weight of hitch receiver 26.

Web 20 may be fabricated from a variety of known flexible materials, such as a heavy duty woven fabric configured to be able to support the weight and not rip, tear, or deform while unloading bulk material 95 from the truck bed.

The bulk material 95 referred to herein may include mulch, gravel, top soil, river rocks, or bricks

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

What is claimed:

1. An unloading device for unloading bulk material from a pickup truck bed, the unloading device comprising:
a rod having a longitudinal axis extending transversely from a left side to a right side relative to a pickup truck bed, the rod rotatable about the longitudinal axis; wherein the rod is positioned rearwardly from the pickup truck bed and the positioning of the rod is independent from movement of a tailgate; and
a web of material including one end of the web attached to the rod and the web spoolable on the rod between an unrolled position and a rolled position;
wherein the web unloads bulk material carried thereby as the web is spooled from the unrolled position to the rolled position.

2. The unloading device of claim 1 defining a gap between the rod and a tailgate top surface when the tailgate is in a lowered position.

3. The unloading device of claim 2, wherein the gap has a horizontal measurement in a range from about 0.25 inches to about 6 inches.

4. The unloading device of claim 2, wherein the gap is about one inch.

5. The unloading device of claim 2, further comprising:
a cross support carrying the rod;
a support arm connected to the cross support configured to couple with a hitch receiver underneath the truck bed.

6. The unloading device of claim 5, wherein the support arm includes:
a first leg having an upwardly facing top surface;
a second leg having an upwardly facing top surface;
the first and second legs connected end to end defining an angle between their respective top surfaces.

7. The unloading device of claim 6, wherein the angle is an obtuse angle.

8. The unloading device of claim 6, wherein when the support arm is coupled with the hitch receiver, the first leg is generally horizontal relative to ground and the second leg extend upwardly and rearwardly from the first leg.

9. The unloading device of claim 6, wherein the first and second legs are pivotably connected to adjust the angle defined between the first and second legs.

10. The unloading device of claim 6, wherein lengths the first and second legs are adjustable.

11. The unloading device of claim 5, further comprising:
a pair of collars, one collar mounted adjacent a first end of the cross support and the other collar mounted adjacent a second end of the cross support;
wherein the pair of collars are concentric with the longitudinal axis of the rod;
a downward and ground facing bottom surface on each one of the pair of collars, wherein the bottom surface faces the ground regardless of the position of the tailgate.

12. The unloading device of claim 5, wherein when the support arm is coupled with the hitch receiver the cross support is at a fixed height relative to ground.

13. The unloading device of claim 2, wherein the web includes:
a first end spaced from a second end, wherein the second end is secured to the rod and a length of the web measured from the first end to the second end, wherein the web length is at least 25% greater than that of the truck bed.

14. The unloading device of claim 13, wherein the rod defines a plurality of bolt receiving threaded apertures configured to receive bolts therein to secure the second end of the web to the rod.

15. The unloading device of claim 1, wherein the web includes a top positioned at a vertical height similar to that of a upwardly facing surface of the tailgate when the tailgate is in a lowered position.

16. The unloading device of claim 1, wherein the web includes a top positioned at a vertical height similar to that of a downwardly facing surface of the tailgate when the tailgate is in a lowered position.

17. The unloading device of claim 1 wherein no part of the unloading device directly contacts the tailgate when the web is in the rolled position.

18. A method of unloading bulk material from a truck bed comprising the steps of:
rotating a rod about a longitudinal axis, wherein the rod is supported by a support arm coupled to a hitch receiver underneath the truck bed;
spooling a web of material onto the rod from an unrolled position to a rolled position, wherein when the web is in the unrolled position, bulk material is disposed on the web;
passing bulk material over a gap defined between the rod and a top surface on a tailgate in a lowered position; and
passing bulk material over a top of the web causing the bulk material to fall to the ground.

19. The method of claim 18, wherein prior to the step of rotating the rod about the longitudinal axis includes the step of:
lowering the tailgate from a generally vertical closed position to a generally horizontal open position, wherein the rod is independent from the lowering movement of the tailgate.

20. An unloading device comprising:
a rod for winding a fabric web therearound, the web configured to unload bulk material from a truck bed when moving from an unwound to a wound position, the web passing over a gap defined between the rod and a truck tailgate; and
a support arm adapted to support the rod at a first end and insert into a truck hitch receiver at a second end.
